(19) United States
(12) Patent Application Publication
(10) Pub. No.: US 2022/0036374 A1
(43) Pub. Date: Feb. 3, 2022

(54) METHOD FOR THE TRACEABILITY AND AUTHENTICATION OF PRODUCTS

(71) Applicant: NOVATEC, Montauban (FR)

(72) Inventors: Francis BOURRIERES, Montauban (FR); Franck BOURRIERES, Montauban (FR)

(21) Appl. No.: 17/277,403

(22) PCT Filed: Sep. 16, 2019
(86) PCT No.: PCT/EP2019/074738

§ 371 Date: Mar. 18, 2021

(30) Foreign Application Priority Data
Sep. 24, 2018 (FR) 1858661

(51) Int. Cl. G06Q 30/00; G06F 16/245

(52) U.S. Cl. CPC G06Q 30/0185; G06F 16/245

(57) ABSTRACT

A method for the traceability and authentication of a product, in which a product is marked with an authenticating element and a tracking element, is provided. The method includes supplying a set of authenticating elements, wherein a digital representation of each authenticating element is recorded in a ED-EA database, generating a set of tracking elements, said tracking elements being recorded in a ED-ESP database, the ED-ESP database being independent of the ED-EA database; and marking products, in which the product is physically associated with a combination formed by an available unique tracking element from the set of tracking elements, and by an independent unique authenticating element from the set of authenticating elements, the combination of the tracking element and the authenticating element not being recorded during the marking step in the respective data-bases or in any other database.

### CROSS REFERENCE TO RELATED APPLICATIONS

This application is a National Stage of International Application No. PCT/EP2019/074738, having an International Filing Date of 16 Sep. 2019, which designated the United States of America, and which International Application was published under PCT Article 21(2) as WO Publication No. 2020/064407 A1, which claims priority from and the benefit of French Patent Application No. 1858661, filed on 24 Sep. 2018, the disclosures of which are incorporated herein by reference in their entireties.

### BACKGROUND

### 1. Field

The present disclosure relates to the field of marking systems for the traceability and the authentication of products.

More particularly the disclosure relates to a method for traceability and authentication of a product.

### 2. Brief Description of Related Developments

Numerous technical solutions are available for identifying and authenticating an original product and differentiating it from another original product of the same type or from a counterfeit. Many of these solutions involve the individual marking of products with security elements that are difficult to reproduce for a counterfeiter.

For example, certain official documents like identity cards, passports and bank notes integrate holographic, magnetic, infrared, and UV elements into a paper support with well-defined characteristics. The presence of the multiple security elements makes the identical reproduction of these objects very difficult, because the production of the object and its marking are complex per se and require very specific technological tools. However, while in these solutions the defined nature of the support facilitates the manufacturing and the reading on a large scale thereof, the complexity is no longer really an obstacle for the counterfeiters who do not hesitate to equip themselves with modern, high-performance technical means.

Other solutions for marking products are less restrictive since they do not use a particular design of the product and the marking is carried out on the packaging of the product. For example, the international patent application No. WO 03/038767 A1 proposes a method for traceability and authentication of the luxury products like bottles of wine. This document proposes assigning to a bottle of wine a cork and a cap including an association of two randomly generated codes, or two combinations of two codes, said combinations of codes being paired in a register of authentic products that the consumer can view remotely. This solution requires the individual marking of each cork and of each cap during the bottling operations, as well as the monitoring and the recording of the combination of the identification codes attributed to each product. The setting up of this solution thus requires the modification of the bottling and/or packaging methods, as well as the simultaneous creation of a database of authentic products that is rather complex and demanding in terms of infrastructure, which is justified when the marked product has a sufficient value.

It is thus of interest today to have available a solution for traceability and authentication that can economically satisfy a use with products having moderate values, the sale price of which does not allow the use of complex implementation methods that would have the consequence of a noticeable increase in the price of the product.

For example, book publishing houses are particularly affected by this issue. Book publishing houses select works for which they accept the risk of financing the necessary steps before the release of a book, for example they take care of the editing and the correction of the text, the page layout, the printing, the promotion, the diffusion, as well as the distribution of the books directly or via a network of resellers.

However, book publishing houses are currently taking up a significant challenge to overcome the economic losses that are generated each year by the sale of counterfeit books that are easily found on the market at a lesser price. The problem is accentuated because it is currently very difficult to distinguish an original book from a pirated or counterfeit book, and by the presence of these counterfeit books in popular commercial networks, in particular on online sales websites.

Indeed, the technologies of digitisation and of printing now allow to clone a book for a low price in a reduced time, without any design effort and with a quality close to that of the printing used by the publishing house. The book publishing houses, and even more so the buyers, thus experience difficulties in identifying a book coming from an original edition.

In practice this situation relates to all the manufacturers of products that have a modest sale price not allowing to use costly protection methods, and for which reproduction methods allow to create their products without design investment at lower manufacturing costs.

There is therefore a need for a method for traceability and authentication of the products that is effective and allows its use at a low cost.

### SUMMARY

For this purpose, the disclosure proposes a method for traceability and authentication of products, wherein a product is marked with an authenticating element and a monitoring element. Said method further includes the following steps:
a step of providing a set of authenticating elements, a digital representation of each authenticating element being recorded in a BD-EA “Database of Authenticating Elements” database;
a step of generating a set of monitoring elements, said monitoring elements being recorded in a BD-ESP “Database of Product Monitoring Elements” database, said BD-ESP database being independent of the BD-EA database;
a step of marking products, in which said product is physically associated with a combination formed by a unique monitoring element, from said set of monitoring elements, and by a unique authenticating element from said set of the authenticating elements, said combination of the monitoring element and of the authenticating element not being recorded during said marking step in the respective databases or in another database.

The method proposed by the disclosure is very advantageous because of the use of two databases created independently and which have minimal needs in terms of infrastructure and management. Moreover, the creation of the databases can be completely independent of the step of marking products.

In another aspect of the present disclosure, the step of generating a set of monitoring elements is carried out conjointly with the step of marking products, the monitoring element for marking said product being generated and saved in the BD-ESP database during the marking of said product.

In one aspect of the disclosure, the monitoring element includes a unique code including an alphanumerical string produced by an algorithm for random or pseudo-random generation of an alphanumerical string. Moreover, the authenticating element includes a visual coming from a chaotic process of integrations of physical elements into a substrate.

The method of the disclosure allows the monitoring and the authentication of a product via a step of verifying the authenticity of a marked product in which:
an authenticating element and a monitoring element of said product are acquired and sent, via a terminal, to a remote verification unit, and
the verification unit carries out a search for said authenticating element in the BD-EA database, and a search for said monitoring element in the BD-ESP database.

The verification of authenticity is positive when the verification unit notes on the one hand the existence of the authenticating element in the BD-EA database and of the monitoring element in the BD-ESP database, and on the other hand said authenticating element is declared available in the BD-EA database and said monitoring element is declared available in the BD-ESP database.

The method of the disclosure can also include a step of updating the databases BD-EA and BD-ESP in which after a first positive verification of the authenticity of a marked product, the verification unit declares the authenticating element and the monitoring element of said product unavailable for a later positive verification of the authenticity of another product.

According to one aspect of the disclosure, the method includes a step of creating a register of the combinations of the authenticating elements with monitoring elements, in which the authenticating element and the monitoring element of the marked product are coupled in said register of the combinations during a first use of said elements in the verification of the authenticity of said product and when the verification concludes the authenticity.

According to one aspect of the disclosure, the marking of products is carried out via at least one marking support including the monitoring element and/or the authenticating element assigned to each product, said support not forming part of the product. Said support can be affixed onto an element separate from the product but accompanying it such as its packaging, its manual, or warranty.

According to one aspect of the disclosure, the monitoring element is only readable when:
the product is unpackaged or ready to be used, or
when an outer covering layer of said monitoring element is visually altered in a non-reversible manner.

Likewise, in addition the authenticating element is only visible when:
the product is unpackaged or ready to be used, or
when an outer covering layer of said authenticating element is visually altered in a non-reversible manner.

### BRIEF DESCRIPTION OF THE DRAWINGS

Other advantages, goals and specific features of the present disclosure will emerge from the following description made, with an explanatory and in no way limiting goal, in reference to the appended drawings.

FIG. 1. A synoptic diagram of an example of implementation of the marking of the products and construction of the databases according to the method of the invention.

FIG. 2. An enlarged view of an example of an authenticating element in the form of a bubble tag authenticating element.

FIG. 3. An example of a monitoring element in the form of an identification code.

FIG. 4. A synoptic diagram of an example of a verification of authenticity according to the method of the invention.

### DETAILED DESCRIPTION

The disclosure proposes a method for traceability and authentication of a product, wherein the product is marked with at least two different elements: a monitoring element and an authenticating element. In practice, the method of the disclosure is used to keep the traceability of the products of a group of products of known origin, as well as to be able to identify and authenticate these products once they are put into use.

FIG. 1 schematically illustrates an aspect of the method for traceability and authentication of the disclosure. The method includes the following steps, taken in any technically operable order:
a step 200 of providing a set of authenticating elements 20, a digital representation of each authenticating element 20 being recorded in a BD-EA “Database of Authenticating Elements” database;
a step 300 of generating a set of monitoring elements 30, said monitoring elements 30 being recorded in a BD-ESP “Database of Product Monitoring Elements” database, said BD-ESP database being independent of the BD-EA database;
a step 400 of marking products, in which said product is physically associated with a combination formed by a unique authenticating element 20 from said set of the authenticating elements, with a unique monitoring element 30 from said set of monitoring elements, and in which said combination is not recorded.

The disclosure thus proposes a method in which the operations necessary for the creation of the databases BD-EA and BD-ESP allowing the monitoring and the authentication of products are simplified. Indeed, the creation of each database is carried out independently and can be completely independent of the marking of the products, which also allows to minimise the needs for infrastructure for their creation and maintenance.

Moreover, a producer wishing to implement the method of the disclosure can keep total confidentiality on the use that they attribute to a set of authenticating elements. For example when a producer wishes to implement the method of the disclosure, they first obtain a set of authenticating elements having no predefined relationship with the products for which they will be used, but for which there is a previous register in a database of authenticating elements BD-EA.

When the producer designates said set of authenticating elements for the marking of a group of products, they independently generate a set of monitoring elements saved in a database for monitoring products BD-ESP. The information allowing to identify said group of products can thus be comprised in the database for monitoring products, or at least linked to said database. The BD-ESP database can be managed, if necessary, only by the producer.

The method of the disclosure also differs by the ease of implementation of the step of marking products. Indeed, each product is randomly associated with an authenticating element 20 and a monitoring element 30 without monitoring and/or making a register of the combination of the monitoring element with the authenticating element assigned to each of the products. It is thus possible to minimise the operations necessary during the marking of the products, without needing equipment for rereading one or the other of the elements, as well as to preserve minimal needs in terms of infrastructure for the databases BD-EA and BD-ESP, since these databases are not configured to make an initial register of the combinations of monitoring element and authenticating element for each product.

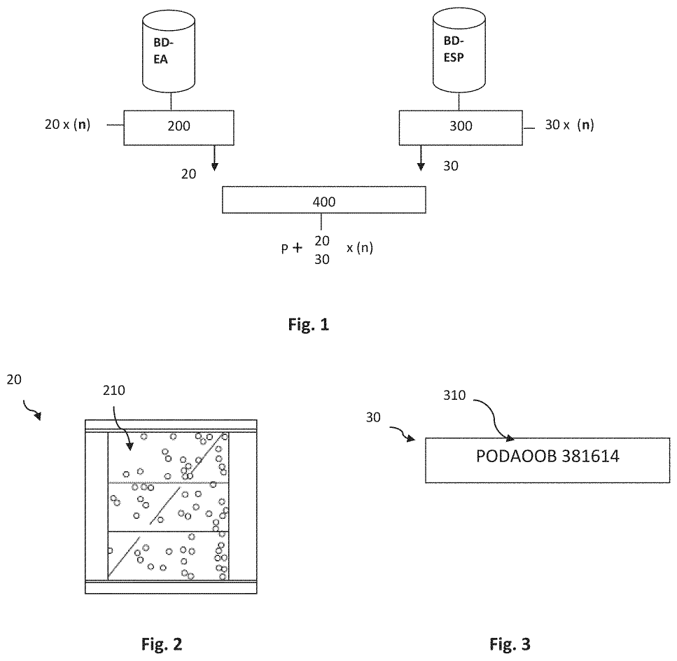

The authentication method of the disclosure preserves, however, a high degree of security because of the use of a unique authenticating element 20 (FIG. 2) and of a monitoring element 30 including a unique code for each product marked (FIG. 3).

The authenticating element 20 can correspond to a visual element 210 of complex reproduction or not reproducible, allowing to authenticate a product with a high degree of security.

In a preferred aspect of the invention, the authenticating element is not reproducible and includes a visual 210 and/or a pattern coming from a chaotic process of generation and of integration of physical elements onto a support. Here, not reproducible means that identical reproduction is impossible in practice, or at least very complex and costly in order for its reproduction to not be technically or economically conceivable for a counterfeiter.

For example an authenticating element can be produced by the random dispersion on a support of glitter or filaments having undetermined different colours, textures and shapes. The authenticating element 30 can also be produced by the chaotic dispersion of bubbles in a polymer (FIG. 2). A pattern thus formed has unique visual characteristics, as well as specific relationships of proportion and distribution among the various graphic elements. The tags or authenticating elements marketed by Prooftag (registered brand) are examples of authenticating element according to the invention.

The “Database of Authenticating Elements” BD-EA includes a digital representation of each of the authenticating elements 20 assigned to a producer, which producer decides to assign all or a part of said authenticating elements to a group of the products, the authenticity of which they wish to be able to be verified by a later owner of a product from said group of products. The representation of an authenticating element 20 in the BD-EA database can include one or more images of said authenticating element and/or one or more keys obtained by the reading of the authenticating element by a defined algorithm.

The verification of the authenticating element in the database is thus carried out via a reading tool adapted to the acquisition of at least one image, if necessary a local processing of the image by an application implemented in the reading tool allowing to determine the key(s) of the authenticating element, and the transmission of the at least one image, if necessary and/or of the key(s) determined locally, to a server of the BD-EA database via a communication network.

The monitoring element 30 includes a unique code 310 attributed to each product to be marked (FIG. 3). This unique code is preferably readable to be reproduced. It consists for example of a sequence of alphanumeric characters or of cryptographic symbols.

The unique codes 310 of the monitoring elements 30 are generated randomly or pseudo-randomly by the implementation of an algorithm so that each identification code has an infinitesimal probability of generation, in practice marginal with respect to the requirements of the method. The possible composition of the codes, that is to say the length and the characters and/or symbols with which the codes are generated, thus allows the formation of a number of different codes much greater than the number of the products to be marked so that a code generated fraudulently will only have a low probability of reproducing a code generated legitimately.

For example, if it is desired to mark 1000 products, the choice of a code composition from ten million possible combinations gives for each code that is fraudulently generated a probability of only one in ten thousand that said fraudulent code corresponds to one of the thousand legitimate codes. Thus an ill-intentioned person cannot by any logic find previously recorded monitoring elements and their “chances” of finding such an element are low, the preceding numerical example not being limiting.

In one aspect of the disclosure, the unique codes 310 share a part of their composition in such a way as to allow the identification of the group of the products to which said code has been assigned. For example, for an edition of books the unique codes 310 assigned to a group of products include a part generated randomly and unique for each code, and a part including the “ISBN” number of the book (standard identification number of the publications in the publishing field). In another aspect of the disclosure, the monitoring element 30 includes a barcode or an optical-reading matrix code including the information on the identity of the product and/or access to a verification unit.

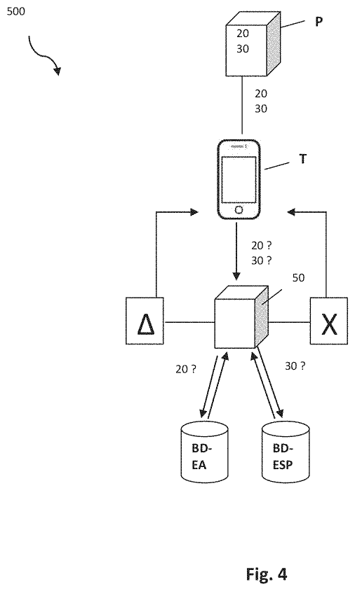

FIG. 4 schematically illustrates the process of a verification of authenticity 500 and of the monitoring of a marked product P according to the disclosure. In this step of the method of the disclosure, a person owning a marked product P queries a verification unit 50 to verify the existence of the authenticating element 20 and of the monitoring element 30 in the databases BD-EA and BD-ESP, respectively. The verification unit is for example a remote server having access to the databases BD-EA and BD-ESP.

In an aspect of the disclosure in which the two databases are totally independent, each one is queried separately by the servers allowing to access them. In this configuration, the double querying is transparent for a user of the reading tool implemented.

The step of verifying authenticity is carried out via a terminal T allowing an acquisition and a sending of the authenticating element 20, image(s) or key(s), and of a monitoring element 30 of the marked product to the verification unit 50. The terminal T corresponds for example to a mobile telephone, a tablet, a computer, or another specific terminal including an optical reader and connected to a communication network. Preferably, the monitoring element also includes a matrix code (QR code) including an internet address to which the terminal has to connect to query the verification unit 50.

During this verification step, the verification unit is queried to independently determine whether each of the monitoring element 30 and the authenticating element 20 is identified and available in the respective BD-EA and BD-ESP databases. In one aspect of the disclosure, the unique code 310 of the monitoring element 30 is first entered or acquired with the terminal T, then said code is transmitted to the verification unit 50 configured to carry out a search in the BD-ESP database to verify whether the monitoring element is identified and available. The verification unit requires the transmission of the data of the authenticating element, image(s) and/or key(s), to continue the verification and search in the BD-EA database if the authenticating element is identified and available. Of course the order in which the elements are sent to the verification unit and searched in the BD-EA and BD-ESP databases can be reversed or carried out in parallel.

The verification unit 50 is configured to authenticate a product after a positive verification A of a presence and of an availability of the authenticating element 20 in the BD-EA database and of the monitoring element 30 in the BD-ESP database. On the contrary, the result of the verification is negative X when the presence and/or the availability of at least one of said elements is not confirmed. In both cases, the verification unit informs the terminal T of the result of the verification of authenticity.

It is thus detected that the product does or does not carry a monitoring element and a legitimate authenticating element determining its authenticity status.

If one or the other or both of the monitoring and authenticating elements are not available, an attempt to reuse said monitoring element and authenticating element, which is associated with a fraudulent attempt, for example for a non-authentic product, is detected.

Presence of an element means that said element is known in a database since a value or a characteristic of said element was saved in said database. Available means that an authenticating 20 or monitoring 30 element is present in a database, and that said element was not used during a previous step of verifying authenticity in which a verification of authenticity was acknowledged.

For this, during the first positive verification of a marked product P, it is recorded in the BD-EA and BD-ESP databases that the authenticating element 20 and the monitoring element 30 used for the authentication of a product are unavailable, each one in their respective databases for a later positive verification. This aspect of the present disclosure allows to prevent the copying of the elements marked on an original product, or their removal, to use them without authorisation and mark a counterfeit product.

In one aspect of the present disclosure, it is possible to increase the speed of searching in the database when the verification unit is configured to verify only the monitoring elements and the authenticating elements declared available. The speed is thus progressively improved since the number of monitoring elements and of authenticating elements available to be verified in the databases decreases in size as the products of the group of the products are identified, authenticated, and their authenticating and monitoring elements are declared unavailable.

In one aspect of the present disclosure, a register of combinations of the authenticating elements with monitoring elements, in which an authenticating element available in the BD-EA database is coupled with a monitoring element available in the BD-ESP database, is created, and said combination of elements is recorded when the verification step has concluded the authenticity of the product. It is thus possible to keep a traceability of the combinations of the monitoring elements with the authenticating elements that were assigned to the products, a traceability of which is desired to be preserved, while preserving the ease of implementation of the marking and the construction of the databases proposed by the invention.

The authentication method of the disclosure is thus advantageous in the after-sale monitoring of the products of a group or batch of products, since it allows not only to carry out the marking of the products allowing their authentication, but also to preserve a traceability of the number of the products that were authenticated and the number of products not yet authenticated. The method also allows to easily detect the counterfeits of a product by the simple absence of marking on the product or by the absence of the authenticating and/or monitoring elements of a marked product in the BD-EA and BD-ESP databases.

For the marking of a product, the authenticating element 20 and the monitoring element 30 can be affixed onto the product, for example by printing or fastening, or onto a piece of accessory documentation or a packaging of the product. Preferably, the two elements are only accessible or readable when the product is unpackaged or ready to be used. The monitoring element can also include an outer covering layer requiring an act of non-reversible alteration to expose the monitoring element, and thus alert a verifier that the monitoring element has already been disclosed. For example the monitoring element can be located under a scratch-off ink, a peelable or destroyable tag.

In one aspect of the disclosure, a product is marked via a marking support including an authenticating element and/or a monitoring element. This aspect of the present disclosure is particularly advantageous when the transfer of the marking support can be carried out by a low-cost method and does not modify or only slightly affects the existing methods for manufacturing the product and its packaging. The marking support can correspond to a paper support including the authenticating element in the form of a tag and the printing of a monitoring element in the form of an identification code. Alternatively, the authenticating element and the monitoring element can be created in different marking supports.

The marking support or supports are thus manufactured separately and added to the product later, for example during the step of packaging the product in its packaging. This aspect of the present disclosure can be used to mark an edition of books of known origin, in such a way as to insert into a book said marking support, before the operations of packaging under a plastic film that are often carried out to protect the books before their sale. Advantageously, in one aspect of the present disclosure the authenticating element 20 is visible from the outside and the monitoring element 30 is only accessible when the packaging has been open/destroyed.

It is thus possible to implement a method for traceability and authentication of products in which the marking of the products and the construction of the database are simplified and do not require the substantial modification of the methods for producing the product or its packaging. Moreover, the characteristics of construction and updating of the database allow to carry out the monitoring and the authentication of a group of products including a large number of products, while preserving an ease of construction and of management of the databases.

The method for traceability and authentication can advantageously be implemented at low cost, and offers a high degree of security in the authentication of a product.

The method for traceability and authentication of the disclosure applies to all sorts of products, such as in a non-limiting manner cosmetic, hygienic, food, clothing, electronic, decorative products, perfumes, books, jewels and any other widespread product. The method is particularly adapted to the products including a packaging or an overwrap allowing to limit the accessibility in particular to the monitoring element. For example, the product can correspond to a tube of toothpaste in its case, a bottle of perfume or cosmetic product in its box, a book in its overwrap, a food product in a can or box, etc.

What is claimed is:

1. A method for traceability and authentication of products, wherein a product is marked with an authenticating element and a monitoring element, which includes:
a step of providing a set of authenticating elements, a digital representation of each authenticating element being recorded in a BD-EA “Database of Authenticating Elements” database;
a step of generating a set of monitoring elements, said monitoring elements being recorded in a BD-ESP “Database of Product Monitoring Elements” database, said BD-ESP database being independent of the BD-EA database;
a step of marking products, in which said product is physically associated with a combination formed by a unique monitoring element, from said set of monitoring elements, and by a unique authenticating element from said set of the authenticating elements, said combination of the monitoring element and of the authenticating element not being recorded during said marking step in the respective databases or in another database.

2. The method for traceability and authentication according to claim 1, wherein the step of generating a set of monitoring elements is carried out conjointly with the step of marking products, the monitoring element for marking said product being generated and saved in the BD-ESP database during the marking of said product.

3. The method for traceability and authentication according to claim 1, wherein the monitoring element includes a unique code including an alphanumerical string produced by an algorithm for random or pseudo-random generation of an alphanumerical string.

4. The method for traceability and authentication according to claim 1, wherein the authenticating element includes a visual coming from a chaotic process of integrations of physical elements into a substrate.

5. The method for traceability and authentication according to claim 1, including a step of verifying the authenticity of a marked product in which:
an authenticating element and a monitoring element of said product are acquired and sent, via a terminal, to a remote verification unit, and
the verification unit carries out a search for said authenticating element in the BD-EA database, and a search for said monitoring element in the BD-ESP database.

6. The method for traceability and authentication according to claim 5, wherein the verification of authenticity is positive when the verification unit notes on the one hand the existence of the authenticating element in the BD-EA database and of the monitoring element in the BD-ESP database, and on the other hand said authenticating element is declared available in the BD-EA database and said monitoring element is declared available in the BD-ESP database.

7. The method for traceability and authentication according to claim 5, including a step of updating the BD-EA and BD-ESP databases in which after a first positive verification of the authenticity of a marked product, the verification unit declares the authenticating element and the monitoring element of said product unavailable for a later positive verification of the authenticity of another product.

8. The method for traceability and authentication according to claim 1, including a step of creating a register of the combinations of the authenticating elements with monitoring elements, in which the authenticating element and the monitoring element of the marked product are coupled in said register of the combinations during a first use of said elements in the verification of the authenticity of said product and when the verification concludes the authenticity.

9. The method for traceability and authentication according to claim 1, wherein the marking of products is carried out via at least one marking support including the monitoring element and/or the authenticating element assigned to each product, said support not forming part of the product.

10. The method for traceability and authentication according to claim 1, wherein the monitoring element is only readable when:
the product is unpackaged or ready to be used, and/or
when an outer covering layer of said monitoring element is visually altered in a non-reversible manner.

11. The method for traceability and authentication according to claim 10, wherein the authenticating element is further only visible when:
the product is unpackaged or ready to be used, and/or
when an outer covering layer of said authenticating element is visually altered in a non-reversible manner.
